(19) United States
(12) Patent Application Publication
(10) Pub. No.: US 2006/0066700 A1
(43) Pub. Date: Mar. 30, 2006

(54) Edge-to-edge printing

(76) Inventor: Charles J. Simpson, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/957,102

(22) Filed: Sep. 30, 2004

(51) Int. Cl. B41J 2/01

(52) U.S. Cl. 347/101

(57) ABSTRACT

A method of and apparatus for printing a borderless image from original image data on a medium having medium dimensions and at least one medium tolerance. The method comprises the acts of determining a ratio between two dimensions of the original image data, determining a sum between the at least one medium tolerance and one of the medium dimensions, stretching one of the image dimensions to at most equal to the sum; and stretching the other image dimension based on the ratio and the increased image dimension. The printing apparatus comprises a ratio transformer to determine a ratio between two dimensions of the original image data, and to determine a sum between the at least one medium tolerance and one of the medium dimensions and an image transformer to stretch one of the image dimensions to at most equal to the sum, and to stretch the other image dimension based on the ratio and the stretched image dimension.

### CROSS REFERENCES TO RELATED APPLICATIONS

None.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Field of the Invention

The present invention relates to a method of printing, and in particular, to a method of printing a borderless image onto a medium.

2. Description of the Related Art

When a printing apparatus prints an image on a medium, the size of the image printed is generally limited by a printable area. The printable area is usually defined by the printing apparatus and is limited by the medium chosen. The limitation is due to the fact that different printers have different medium tolerances, such as placement tolerance and width tolerance. As a result, each medium will have blank borders, which the printing apparatus will bypass during printing, even when the image to be printed has the same aspect ratio as that of the medium. Depending on the printing apparatus, the width of the blank borders ranges from 2 mm to 5 mm. In other words, while a majority of the medium is used, part of the medium is left blank. Not only are these borders undesirable to look at when left blank, a considerable amount of the potentially printable image data is sometimes left out of the image printed on the medium.

### SUMMARY OF THE INVENTION

Accordingly, there is a need for a method of printing borderless images on media. In one form, the invention provides a method of printing a borderless image from original image data on a medium having medium dimensions and at least one medium tolerance. The method comprises the acts of determining a ratio between two dimensions of the original image data, and determining a sum between the at least one medium tolerance and one of the medium dimensions. Thereafter, the method comprises the acts of stretching one of the image dimensions to at most equal to the sum, and stretching the other image dimension based on the ratio and the increased image dimension.

In another form, the invention provides a method of printing a borderless image from original image data on a medium having medium dimensions, and at least one medium tolerance. The method comprises the acts of determining a ratio between two dimensions of the original image data, and matching one of the image dimensions of the original image data with one of the medium dimensions and one of the at least one medium tolerance. The method also comprises of the acts of stretching the image data based on the matched dimension, and stretching the other image dimension based on the ratio and the stretched image data.

In yet another form, the invention provides a printing apparatus adapted to print a borderless image from original image data onto a medium having medium dimensions and at least one medium tolerance. The printing apparatus comprises a ratio transformer to determine a ratio between two dimensions of the original image data, and to determine a sum between the at least one medium tolerance and one of the medium dimensions. The printing apparatus also comprises an image transformer to stretch one of the image dimensions to at most equal to the sum, and to stretch the other image dimension based on the ratio and the increased image dimension.

Other features and advantages of the invention will become apparent to those skilled in the art upon review of the following detailed description, claims, and drawings.

### BRIEF DESCRIPTION OF THE DRAWINGS

In the drawings:

FIG. 1 shows a printing apparatus embodying the invention;

FIG. 2 shows a table listing stretch factors for a plurality of media;

FIG. 3 is a conceptual representation showing a CMYK print head printing on an absorbent pad according to an embodiment of the invention;

FIG. 4 shows a medium divided into different portions according to one embodiment of the invention;

FIG. 5A shows a table listing nozzle advancement according an embodiment of the invention;

FIG. 5B shows a second table listing nozzle advancement according an embodiment of the invention;

FIG. 5C shows a third table listing nozzle advancement according an embodiment of the invention;

FIG. 5D shows a fourth table listing nozzle advancement according an embodiment of the invention;

FIG. 5E shows a fifth table listing nozzle advancement according an embodiment of the invention; and

FIG. 6 is a flow chart illustrating processes occurring in some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. In addition, the terms “connected” and “coupled” and variations thereof are not restricted to physical or mechanical connections or couplings.

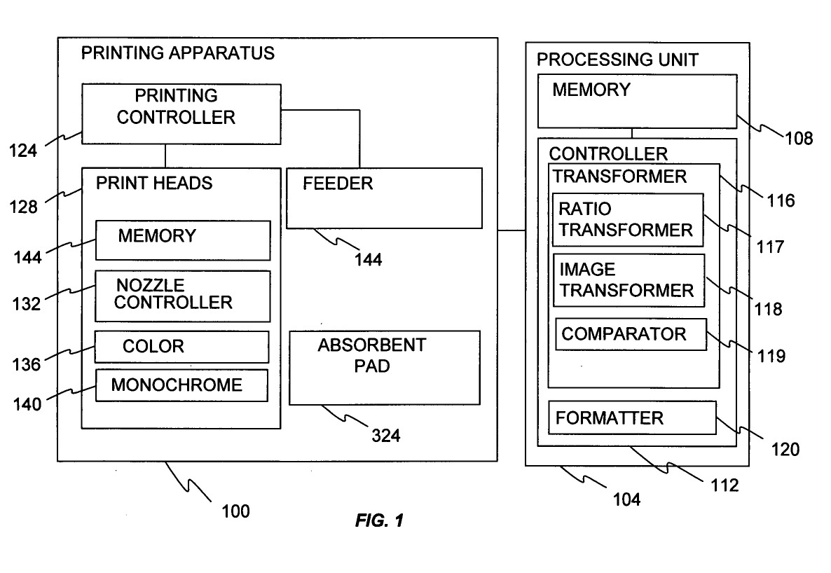

FIG. 1 shows a printing apparatus 100 coupled to a processing unit 104 such as a computer, a control panel, and the like. Exemplary printing apparatuses include all-in-one devices, inkjet printers, and the like. Although FIG. 1 shows that the printing apparatus 100 and the processing unit 104 being separate devices, the processing unit 104 can be embedded in the printing apparatus 100. The processing unit 104 includes a memory 108 that stores an original image queued to be printed onto a medium whose operating parameters such as dimensions and dimension aspect ratio are also stored. The medium aspect ratio is typically determined by comparing two medium dimensions such as between the nominal width and the nominal length of the medium. Of course, other arrangements can also be used to determine the medium aspect ratio.

Once a borderless print option has been selected, the original image is queued for processing or transforming before being printed. Initially, the transformation involves a controller 112 determining the dimensions of the original image, and determining an image aspect ratio using the dimensions of the original image. Specifically, the controller 112 includes a transformer 116 that manipulates the image data. For example, a ratio transformer 117 determines the image aspect ratio using the measured dimensions of the original image. Thereafter, the original image is stretched in an image transformer 118 according to the image aspect ratio determined and the medium parameters retrieved. Specifically, one of the original image dimensions, such as the width of the original image, is then stretched or increased in the image transformer 118 so that the stretched image dimension sufficiently covers a width sum of the corresponding medium width and the width tolerance associated with the selected medium. Using the determined image aspect ratio, the medium dimensions retrieved from the memory 108 and the width sum, the remaining image dimension is similarly stretched or proportionally increased. In this way, the stretched image keeps the same image aspect ratio, thus not distorting the image. The transformation process is detailed hereinafter.

The transformation process to produce a borderless copy specifically requires that the original image be stretched slightly in order to accommodate size and positional tolerances in the printing process. That is, the image stretching is used to insure the printed image goes to or beyond all medium dimensions and all tolerances. In this way, the transformation process and thus the printing process will cover the entire medium, and therefore yield a borderless copy of the original image.

The initial act in a borderless image stretching or transformation process is to increase the width of the original image sufficiently to cover the entire width of the medium including the tolerances on medium placement and medium dimensional tolerance. A typical medium placement tolerance is approximately ±1 mm, while a typical medium dimensional tolerance on the width is approximately ±2 mm. As a result, to completely include the width tolerance, the width of the original image can be increased horizontally by a sum of all the tolerances, 4 mm in the example. However, in order to reduce an ink overspray buildup on a side waste ink area, a width increment less than the sum of all the tolerances is generally chosen, for example, 3 mm. That is, the width of the original image is only transformed or incremented by the width increment amount, generally less than the sum of all the tolerances. Although the chosen width increment amount is less than the sum of all the tolerances, other transformations, increments, or stretching amounts can also be used depending on the printing apparatus requirements. However, the 3-mm width increment is generally acceptable because most printing medium tolerances, especially photo medium tolerances, are better than what the printing apparatus specifies.

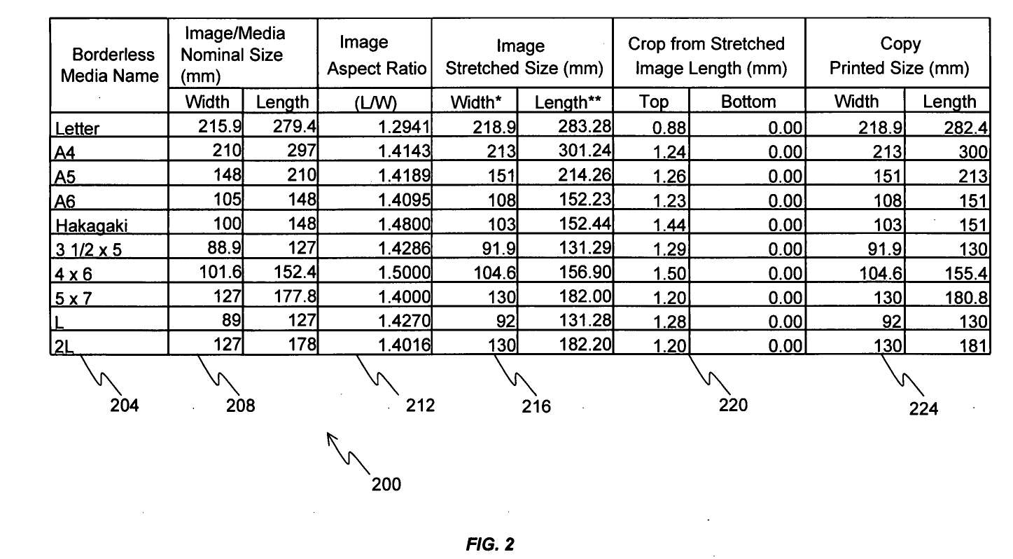

Furthermore, in order to maintain the proportions or the aspect ratios of the original image, the other medium dimension of the original image such as the length is also proportionally stretched or transformed. Specifically, the other image dimension is stretched by a product between the image aspect ratio and the stretched image dimension. For example, if the width and the length of an image are 215.9 mm and 279.4 mm, respectively, the image aspect ratio between the length and the width is therefore 279.4/215.9=1.2941. If the width increment is 3 mm, the stretched image will have a width of (215.9 mm+3 mm)=218.9 mm. Thereafter, the length of the image is proportionally stretched to (218.9 mm×1.2941)=283.28 mm to maintain the original image aspect ratio. FIG. 2 shows a borderless stretching table 200 detailing the dimensions and stretched dimensions for a plurality of borderless media sizes. In table 200, column 204 lists a plurality of medium names, column 208 lists the nominal dimensions of a particular media, column 212 lists a corresponding aspect ratio, and column 216 lists the dimensions of a stretched image.

Referring back to FIG. 1, after the original image has been proportionally stretched, the transformer 116 will compare the stretched image length with the medium length. Specifically, a length increment, generally the same as the width increment, is initially added to the length of the medium to cover a length tolerance of the medium, and to generate a tolerated medium length. The length of the stretched image is then compared to the tolerated medium length. In the example discussed earlier, if the length increment is chosen to be 3 mm, the tolerated medium length is therefore (279.4 mm+3 mm)=282.4 mm. Although the length increment is chosen in the example to be the same as the width increment, other amounts of width increment and length increment or no length increment can also be used depending on the printing apparatus used. If the tolerated medium length is larger than the length of the stretched image, the tolerated medium length is then used to generate the dimensions of the stretched image. In this case, the stretched image length is set equal to the tolerated medium length and this value is divided by the previously mentioned original image aspect ratio to obtain the stretched image width. A process similar to that described below is then used to determine the amount of the stretched image width that must be cropped or removed to make it equal to the tolerated medium width.

The tolerated medium length is typically less than the length of a stretched image. That is, when comparing the length of the stretched image with the tolerated medium length at a comparator 119, a length difference or a medium delta is obtained. As a result, the medium delta is cropped or removed from the stretched image at the image transformer 118. For the example discussed, the stretched image has length of 283.28 mm, the tolerated medium length is 282.4 mm, and the medium delta is therefore 0.88 mm. Consequently, 0.88 mm of the stretched image length is cropped off. Column 220 of table 200 lists a plurality of crop amounts for different types of media. More specifically, the “Crop from Image Length” column 220 lists an amount of the “image stretched size” to be cropped by the image transformer 118 from the top of a stretched image before formatting for printing. The amount of cropping keeps the resultant printed image centered on a nominally sized medium and minimizes excessive ink overspray into the horizontal borderless waste ink areas. Also, the cropping is taken at the top of the stretched image to keep the center of the stretched image as close as possible to the center of the nominal medium. The “Printed Size” column 224 lists a resultant size of a formatted print image to be sent to the printing apparatus 100 after the cropping is performed.

After the original image has been incremented, stretched, transformed, and cropped to obtain the print image, the printing apparatus 100 can queue the image for printing. Assuming a printing apparatus having a printing resolution of 1/600″ per pel, the printing process generally starts at 0.5 mm or 12 pels before the nominal top edge of the medium, and 1 mm or 24 pels before the nominal left edge of the selected medium. Of course, other starting top edge pels and left edge pels can also be used depending on the printing apparatus, and the associated medium placement tolerances on the printing apparatus. That is, if the placement tolerance and the dimensional tolerance on a different printing apparatus are different, the starting top edge pels and the starting left edge pels will be different.

The controller 112 also generates a plurality of formatter codes in a formatter 120 and sends those codes to the printing apparatus 100 with the cropped image for printing. In one embodiment, the formatter 120 receives a stretched and cropped image with a length greater than the length of the chosen medium. For example, if the chosen medium is a letter size which has the dimensions of 8.5″×11″ (215.9 mm×279.4 mm), the formatter 120 will receive a formatted image that has a length of 11″+3 mm, and will generate formatter codes of a printing image with a length of 11″+3 mm.

In some embodiments, the processing unit 104 and its functions described are implemented in a combination of firmware, software, hardware, and the like. To be more specific, as illustrated in FIG. 1, the controller 112 communicates with other modules (as discussed) such as the formatter 120 that are drawn as if these modules were implemented in hardware. However, the functionality of these modules could be implemented in software, and that software could, for example, be stored in the memory 108 and executed by the controller 112.

Referring back to FIG. 1, when the printing apparatus 100 starts to print, a printing apparatus controller 124 will activate a print head 128. The print head 128 will in turn activate the nozzles 132 that include both color nozzles 136 and monochrome nozzles 140. The print head 128 also has a memory 144 to store various types of information relating to the print head 128 such as ink levels. The printhead can be composed of a color printhead having three parallel columns of nozzles providing cyan, magenta and yellow inks, respectively, and a monochrome printhead having one of more parallel columns of nozzles providing black ink. By convention, the nozzles are numbered from the top down. The print height of the print swaths in the color and monochrome printheads can be of the same height or can be different.

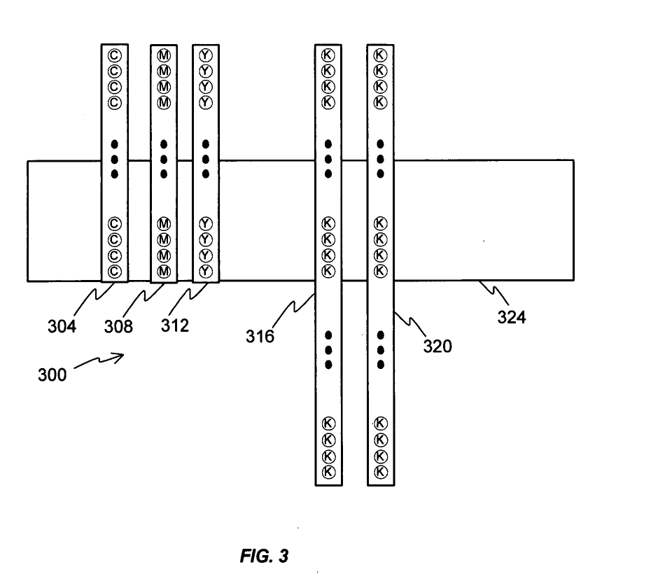

When the printing apparatus 100 starts to print adjacent the top edge of the medium, a first group of the color print head nozzles 136 and a second group of the monochrome nozzles 140 are activated to spray ink onto the medium. Positioned beneath the top edge of the medium and these groups of print head nozzles 136, 140 is an absorbent pad or ink gutter to contain and to absorb any ink that is sprayed off the medium. FIG. 3 shows a conceptual representation of the color (C, M, Y—cyan, magenta, yellow, respectively) and black or monochrome (K—black) print heads. The color printhead has nozzle columns 304, 308, 312, for C, M, and Y inks, respectively, each having, for purposes of illustration, 160 nozzles. The monochrome printhead has two nozzle columns 316 and 320, both for K ink and each having, for purposes of illustration, 320 nozzles. For each printhead, a portion of each column is positioned over an absorbent pad 324 where the print heads and medium are horizontally oriented or is positioned behind the medium where the print heads and medium are vertically oriented. For each of the printheads illustrated, approximately 80 nozzles in each nozzle column would be positioned over the absorbent pad 324. The number of nozzles positioned over the pad 324 can be greater or fewer than those illustrated. FIG. 3 also illustrates that the height print swath of the monochrome print head that is twice that of the CMY print heads 304. Other numbers and arrangement of nozzles can be used.

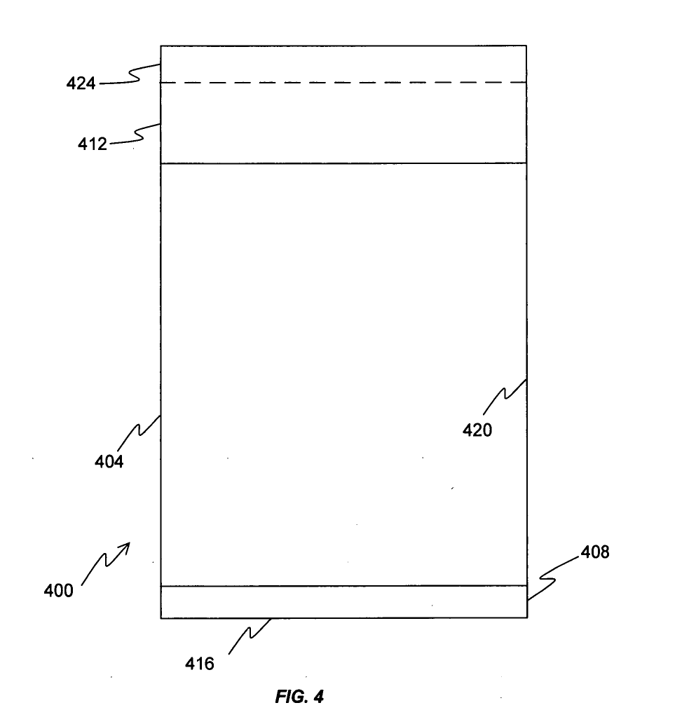

FIG. 4 shows an exemplary medium 400 with three different portions 404, 408, and 412, medium width 416, and medium length 420. The first portion or the “on the page” portion 404 indicates an area of the medium 400 on which any of the nozzles 136, 140 can be used to print. Typically, the “on the page” portion 404 is less than the medium length 420. Questionable portions 408 and 412 of FIG. 4 are areas of the medium in which the printing apparatus 100 prints with the nozzles 136, 140 that are positioned over the absorbent pad 324. Portion 408 is considered questionable because portion 408 generally accounts for an initial medium feed tolerance, while portion 412 generally accounts for several tolerances such as feed tolerance, placement tolerance, medium variation, and the like. As a result, FIG. 4 shows that portion 408 is smaller than portion 412 and, in some cases can be considerably smaller. FIG. 4 also shows with a dashed line the medium delta defining a portion 424 within portion 412 obtained from the cropping discussed earlier.

When printing portions 408 and 412 of the medium 400, the CMY print head generally uses a first number, for example 80 or nozzle 0 to nozzle 79, of the available 160 color nozzles 136. Meanwhile, the K print head 140 generally uses a second number, for example 160 black nozzles or nozzle 160 to nozzle 239 of nozzle column 316 and nozzle 480 to nozzle 559 of nozzle column 320, of the available 640 monochrome nozzles 140 to print. Therefore, a number of color nozzles and monochrome nozzles are not used during the printing process or the initial swaths around the top and bottom edges of the medium 400. Since a reduced number of the available nozzles are used, the printing controller 124 will control the medium feeding or advancing differently in a feeder 144, detailed hereinafter. As described, the number of the color nozzles per color used during the initial swaths is about half of the number of the monochrome nozzles, or 1-to-2 ratio. Furthermore, the number of CMYK nozzles used during the initial swaths is typically about half of all of the available nozzles. In this way, a shingling mode as is known by those of skill in the art can be used to print both borderless and bordered images. Thus, the printing apparatus 100 can provide a consistent print quality in both printing modes.

As the nozzles 136, 140, pass portion 408, the printing apparatus 100 will start to print in portion 404. During this passage, the printing apparatus 100, or the printing controller 124 will transition from using a subset of nozzles 136, 140 covered by the absorbent pad 324 to using, if needed, all the nozzles 136, 140. The transition specifically begins when a plurality of the leading nozzles 136, 140 positioned over by the absorbent pad 324 start printing on the portion 408 of FIG. 4. Better print quality occurs when the transition happens gradually and smoothly. In one embodiment, the number of nozzles used is directly proportional to a medium feed amount determined by the feeder 144. For example, the printing controller 124 increases the number of nozzles used by a 600 dots-per-inch (“dpi”) equivalent of the paper feed amount. The transition thus requires no extra swaths of the print head 128. Once portion 408 has been completely printed, the feeder 144 can immediately transition from a small paper feeding rate to a full paper feeding rate which than can use, if needed, all of the nozzles 136, 140 on the print head 128 to print in portion 404.

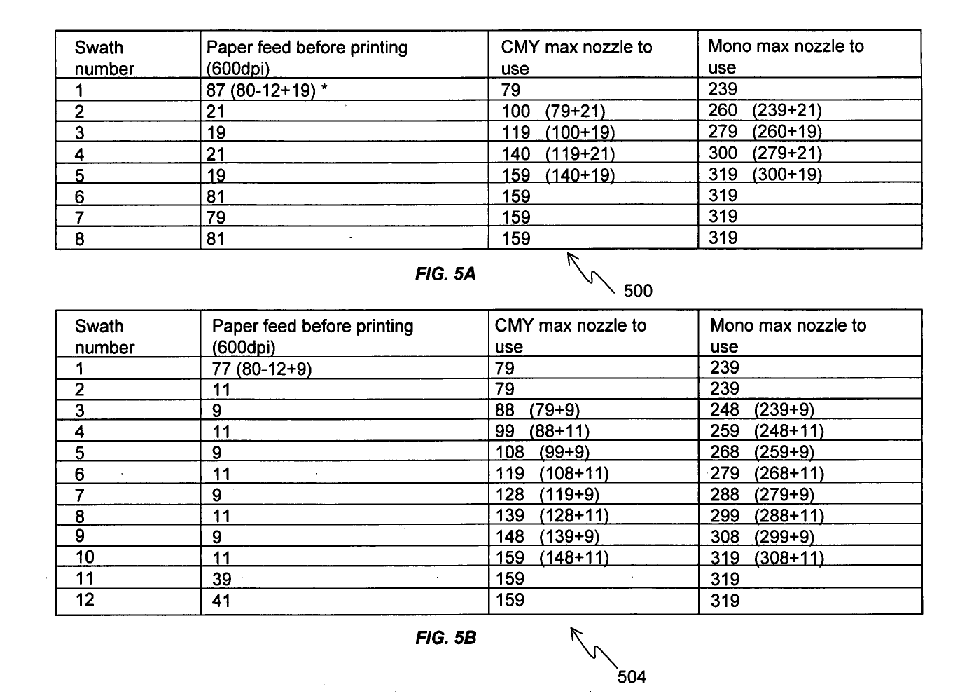

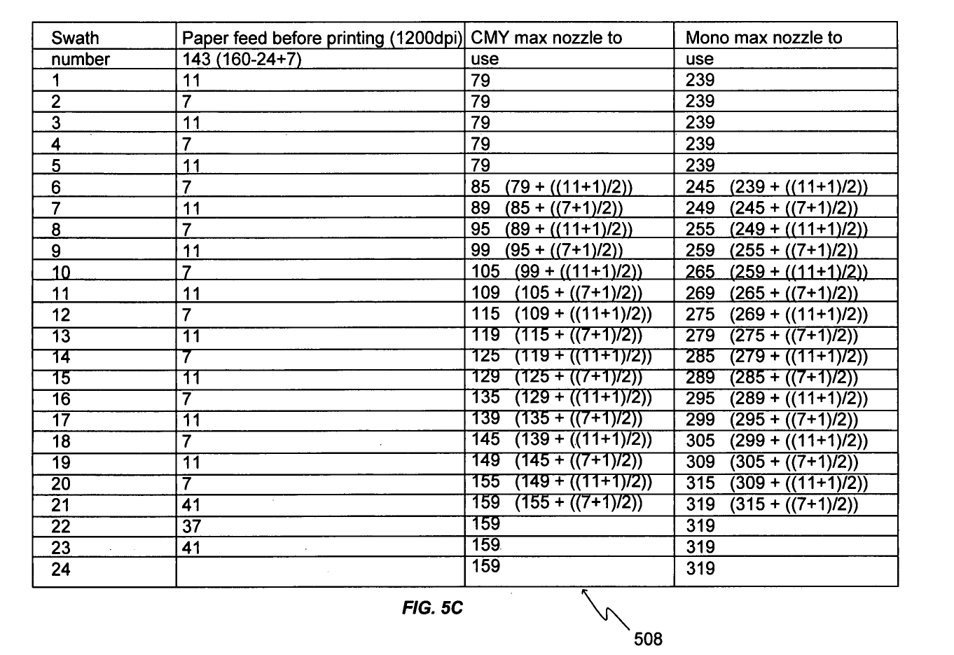

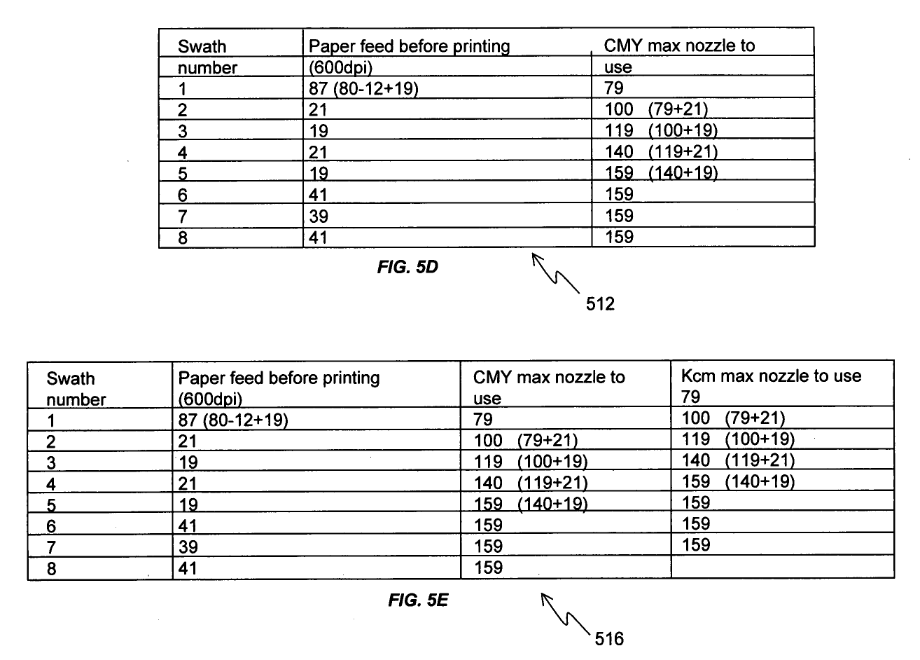

FIGS. 5A, 5B, and 5C show three tables 500, 504, and 508, respectively. Each of the tables 500, 504, and 508 shows a number of nozzles used, and a medium feed amount according to the invention. For example, table 500 shows a printing sequence for a CMYK printing apparatus with a 600-dpi resolution and a two pass printing scheme. Similarly, table 504 shows a printing sequence for CMYK printing apparatus with a 600-dpi resolution and a four pass printing scheme. Table 508 shows a printing sequence for CMYK printing apparatus with 1200 dpi resolution and an eight pass printing scheme. On the other hand, if only the color print heads are used, all color nozzles 136 positioned over the absorbent pad 324 can be used to print the top edge of the medium. FIG. 5D shows a table 512 listing nozzles used to print and a medium feed amount in a CMY printing process with a 600 dpi resolution and a four pass printing scheme.

When printing with the color and photo print heads 128, all 80 color nozzles and all 80 photo nozzles covered by the absorbent pad 324 can be used to print the portion 408 of the medium 400 because the color and photo print heads 128 have a 1-to-1 head size ratio. FIG. 5E shows a table 516 listing the nozzles used and a medium feed amount in a CMYKcm photo printing process with a 600-dpi resolution and a four pass printing scheme where “c” and “m” indicate a less intense cyan and magenta color, respectively being used in the photo print head.

When the portion 412 is being printed, the printing process is similar. Specifically, when the portion 412 moves onto the print head 128 to be printed, the printing is delayed until the print head 128 is using the nozzles 136, 140 over the absorbent pad 324. Initially, when the portion 412 is about to reach the region of the pad 324, the feeder 144 changes the medium feed amounts from full advancing to a fraction of full advancing amount. Using CMYK with a 1200 dpi resolution and eight pass printing scheme as an example, the paper feed amounts in dots of the 1200 dpi resolution will change from a normal 37/41 dots sequence to the borderless 7/11 dots sequence. The smaller paper feed amounts can then be used to print the rest of the page.

To vertically align between print heads, if the absorbent pad 324 is large enough, the same absorbent pad 324 can be used. In this way, the controller 124 can continue to use C, M, and Y nozzles 0 to 79 and K nozzles 160 to 239 regardless of vertical alignment. On the other hand, the nozzles used in the nozzle columns can be changed to align the print heads so that the nozzles used are covering the same raster line of the image being printed. For example K nozzles 158 to 237 could be used instead of 160 to 239.

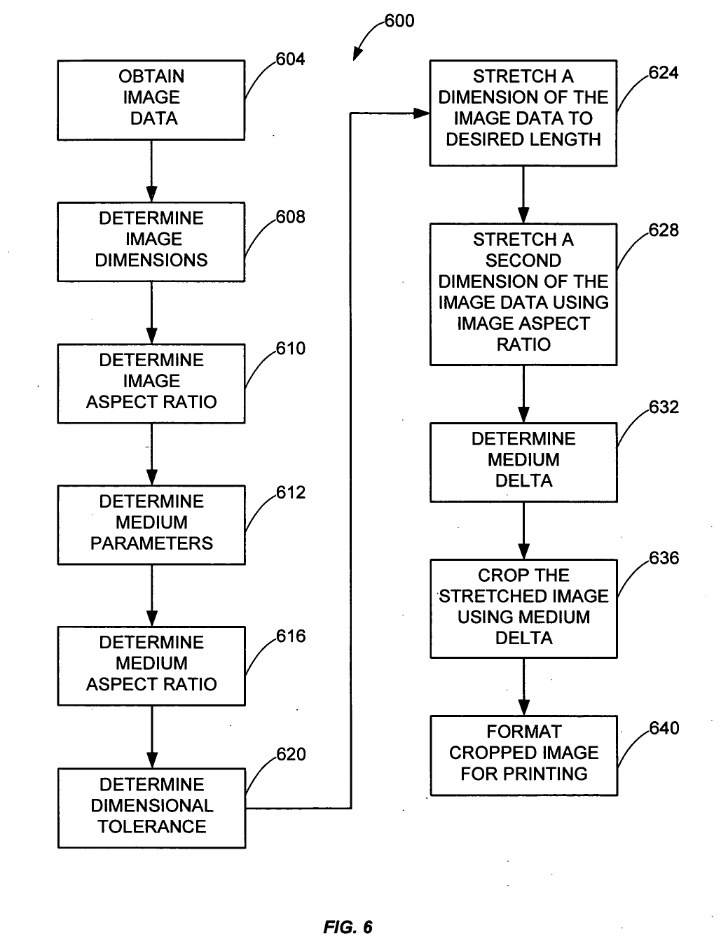

FIG. 6 is a flow chart 600 that further illustrates processes that occur in some embodiments including processes that may be carried out by software, firmware, or hardware. After image data has been acquired, for example, from the memory 144 (FIG. 1) at block 604, the controller 112 (FIG. 1) determines the dimensions of the image at block 608, and the ratio transformer 117 determines the aspect ratio of the image at block 610. Thereafter, a plurality of medium parameters such as the length and the width are determined or retrieved at block 612. The medium aspect ratio and the dimensional tolerance are also determined at blocks 616 and 620, respectively, in manner described earlier.

The image is subsequently stretched. Specifically, one of the original image dimensions, such as the width of the original image, is then stretched or increased at block 624 so that the stretched image dimension sufficiently covers the width sum as described earlier. Using the image aspect ratio determined at block 610, the medium dimensions retrieved from the memory 108 and the width sum, the second or the remaining image dimension is similarly stretched or proportionally increased at block 628. In this way, the stretched image keeps the same image aspect ratio, thus not distorting the image. Specifically, the other image dimension is stretched by a product between the image aspect ratio and the stretched image dimension at block 628. After the original image has been proportionally stretched in both dimensions, a medium delta as defined earlier is obtained at block 632 from the length of the stretched image and the medium tolerance in a manner discussed. The medium delta is then subtracted or cropped from the stretched image at block 636. The resulting image data is then formatted at block 640 for printing.

Various features and advantages of the invention are set forth in the following claims.

1. A method of printing a borderless image from original image data on a medium having medium dimensions, and at least one medium tolerance, the method comprising the acts of:
determining a ratio between two dimensions of the original image data;
determining a sum between the at least one medium tolerance and one of the medium dimensions;
stretching one of the image dimensions to at most equal to the sum; and
stretching the other image dimension based on the ratio and the stretched image dimension.

2. The method of claim 1, further comprising:
comparing the other stretched image dimension to the other medium dimension thereby yielding a medium delta; and
cropping off the medium delta from the other stretched image dimension.

3. The method of claim 1, further comprising:
comparing the other stretched image dimension to the other medium dimension;
if the other medium dimension is larger than the other stretched image dimension, stretching the other stretched image dimension to be at least equal to the other medium dimension; and,
if the other medium dimension is smaller than the other stretched image dimension, determining a medium delta and cropping off the medium delta from the other stretched image dimension.

4. The method of claim 1, wherein the at least one medium tolerance comprise at least one of a medium location tolerance and a medium dimension tolerance.

5. The method of claim 1, further comprising the act of centering the stretched image at a center of the medium.

6. The method of claim 1, further comprising the act of advancing the medium at a different rate when the print head nozzles are adjacent a first medium dimension than when the print head nozzles are away from the first medium dimension.

7. The method of claim 1, further comprising the acts of:
positioning the medium adjacent an absorbent pad; and
absorbing ink sprayed off the medium with the absorbent pad.

8. The method of claim 2, wherein the cropping of the medium occurs at the top of the stretched image.

9. A method of printing a borderless image from original image data on a medium having medium dimensions, and at least one medium tolerance, the method comprising the acts of:
determining a ratio between two dimensions of the original image data;
matching one of the image dimensions of the original image data with one of the medium dimensions and one of the at least one medium tolerance;
stretching the image data based on the matched dimension and medium tolerance; and
stretching the other image dimension based on the ratio and the stretched image data.

10. The method of claim 9, further comprising:
determining a sum between the matched image dimension of the original image data and the one of the at least one medium tolerances; and
stretching the other image dimension based on the ratio and the sum.

11. The method of claim 9, further comprising the acts of:
comparing the other stretched image dimension to the other medium dimension thereby yielding a medium delta; and
cropping off the medium delta from the other stretched image dimension.

12. The method of claim 1, further comprising:
comparing the other stretched image dimension to the other medium dimension;
if the other medium dimension is larger than the other stretched image dimension, stretching the other stretched image dimension to be at least equal to the other medium dimension; and,
if the other medium dimension is smaller than the other stretched image dimension, determining a medium delta and cropping off the medium delta from the other stretched image dimension.

13. The method of claim 9, further comprising the acts of:
adding an increment to the other medium dimension;
comparing the other stretched image dimension to the incremented other medium dimension thereby yielding a medium delta; and
cropping off the medium delta from the other stretched image dimension.

14. The method of claim 9, wherein the at least one medium tolerance comprise at least one of a medium location tolerance and a medium dimension tolerance.

15. The method of claim 9, further comprising the act of centering the stretched image at a center of the medium.

16. The method of claim 9, further comprising the acts of:
moving the medium over a fixed absorbent pad; and
absorbing ink sprayed off the medium with the fixed absorbent pad.

17. The method of claim 9, wherein the act of matching comprises the act of increasing one of the image dimensions to equal one of the medium dimensions and one of the at least one medium tolerance.

18. The method of claim 11, wherein the cropping of the image occurs at the top of the stretched image.

19. The method of claim 12, wherein the cropping of the image occurs at the top of the stretched image.

20. The method of claim 13, wherein the cropping of the image occurs at the top of the stretched image.

21. A printing apparatus adapted to print a borderless image from original image data onto a medium having medium dimensions, and at least one medium tolerance, the printing apparatus comprising:
a ratio transformer adapted to determine a ratio between two dimensions of the original image data, and to determine a sum between the at least one medium tolerance and one of the medium dimensions; and
an image transformer adapted to stretch one of the image dimensions to at most equal to the sum, and to stretch the other image dimension based on the ratio and the increased image dimension.

22. The printing apparatus of claim 21, further comprising a comparator configured to compare the other stretched image dimension to the other medium dimension thereby yielding a medium delta; and wherein the image transformer is further adapted to crop off the medium delta from the other stretched image dimension.

23. The printing apparatus of claim 21, further comprising a comparator configured to compare the other stretched image dimension to the other medium dimension and if the other medium dimension is larger than the other stretched image dimension, the image transformer is further adapted to stretch the other stretched image dimension to be at least equal to the other medium dimension and, if the other medium dimension is smaller than the other stretched image dimension, the comparator determines a medium delta and the image transformer is further adapted to crop off the medium delta from the other stretched image dimension.

24. The printing apparatus of claim 21, and wherein the at least one medium tolerance comprise at least one of a medium location tolerance and a medium dimension tolerance.

25. The printing apparatus of claim 18, further comprising a fixed absorbent pad adapted to absorb excessive ink sprayed off the medium.

26. The printing apparatus of claim 18, and wherein the image transformer is further adapted to estimate an amount of ink overspray at one side of the medium.

27. The printing apparatus of claim 18, and wherein the image transformer is further adapted to center the stretched image at a center of the medium.

28. The printing apparatus of claim 18, wherein the image transformer is further adapted to crop off the medium delta from the top of other stretched image dimension.
